(19) United States
(12) Patent Application Publication
(10) Pub. No.: US 2025/0212123 A1
(43) Pub. Date: Jun. 26, 2025

(54) CONFIGURED POWER UP TIME FOR ENERGY HARVESTING DEVICE

(71) Applicant: QUALCOMM Incorporated, San Diego, CA (US)

(72) Inventors: Ahmed ELSHAFIE, San Diego, CA (US); Zhikun WU, Beijing (CN); Huilin XU, Temecula, CA (US); Yuchul KIM, San Diego, CA (US); Seyedkianoush HOSSEINI, San Diego, CA (US); Linhai HE, San Diego, CA (US)

(21) Appl. No.: 18/848,270

(22) PCT Filed: May 11, 2022
(86) PCT No.: PCT/CN2022/092196

§ 371 Date: Sep. 18, 2024

(51) Int. Cl. H04W 52/02; H02J 50/00

(52) U.S. Cl. CPC H04W 52/0235; H02J 50/001

(57) ABSTRACT

Various aspects of the present disclosure generally relate to wireless communication. In some aspects, a wireless device may receive a power up signal that is configured. The wireless device may transmit a backscattering signal that includes information bits, or receive commands or bits, at a power up time after starting the receiving of the power up signal. Numerous other aspects are described.

### FIELD OF THE DISCLOSURE

Aspects of the present disclosure generally relate to wireless communication and to techniques and apparatuses for using an energy harvesting duration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless device. The method may include receiving a power up signal. The method may include transmitting a backscattering signal that includes information bits, or receiving commands or bits, at a power up time after starting the receiving of the power up signal, where the power up time is configured.

Some aspects described herein relate to a method of wireless communication performed by a wireless device. The method may include transmitting a power up signal. The method may include receiving a backscattering signal that includes information bits, or transmitting commands or bits, at a power up time after starting the transmitting of the power up signal, where the power up time is configured or searched for.

Some aspects described herein relate to a wireless device for wireless communication. The wireless device may include a memory and one or more processors coupled to the memory. The one or more processors may be configured to receive a power up signal. The one or more processors may be configured to transmit a backscattering signal that includes information bits, or receive commands or bits, at a power up time after starting reception of the power up signal, where the power up time is configured.

Some aspects described herein relate to a wireless device for wireless communication. The wireless device may include a memory and one or more processors coupled to the memory. The one or more processors may be configured to transmit a power up signal. The one or more processors may be configured to receive a backscattering signal that includes information bits, or transmit commands or bits, at a power up time after starting transmission of the power up signal, where the power up time is configured or searched for.

Some aspects described herein relate to a non-transitory computer-readable medium that stores a set of instructions for wireless communication by a wireless device. The set of instructions, when executed by one or more processors of the wireless device, may cause the wireless device to receive a power up signal. The set of instructions, when executed by one or more processors of the wireless device, may cause the wireless device to transmit a backscattering signal that includes information bits, or receive commands or bits, at a power up time after starting the receiving of the power up signal, where the power up time is configured.

Some aspects described herein relate to a non-transitory computer-readable medium that stores a set of instructions for wireless communication by a wireless device. The set of instructions, when executed by one or more processors of the wireless device, may cause the wireless device to transmit a power up signal. The set of instructions, when executed by one or more processors of the wireless device, may cause the wireless device to receive a backscattering signal that includes information bits, or transmit commands or bits, at a power up time after starting transmission of the power up signal, where the power up time is configured or searched for.

Some aspects described herein relate to an apparatus for wireless communication. The apparatus may include means for receiving a power up signal. The apparatus may include means for transmitting a backscattering signal that includes information bits, or receiving commands or bits, at a power up time after starting the receiving of the power up signal, where the power up time is configured.

Some aspects described herein relate to an apparatus for wireless communication. The apparatus may include means for transmitting a power up signal. The apparatus may include means for receiving a backscattering signal that includes information bits, or transmitting commands or bits, at a power up time after starting the transmitting of the power up signal, where the power up time is configured or searched for.

Aspects generally include a method, apparatus, system, computer program product, non-transitory computer-readable medium, user equipment, wireless device, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of energy harvesting, in accordance with the present disclosure.

FIG. 5 is a diagram illustrating an example of backscatter communication, in accordance with the present disclosure.

FIG. 6 is a diagram illustrating an example associated with using a reserved energy harvesting duration to harvest energy, in accordance with the present disclosure.

FIG. 7 is a diagram illustrating an example of subbands for backscattering, in accordance with the present disclosure.

FIG. 8 is a diagram illustrating an example of using repetitions, in accordance with the present disclosure.

FIG. 9 is a diagram illustrating an example process performed, for example, by a wireless device, in accordance with the present disclosure.

FIG. 10 is a diagram illustrating an example process performed, for example, by a wireless device, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

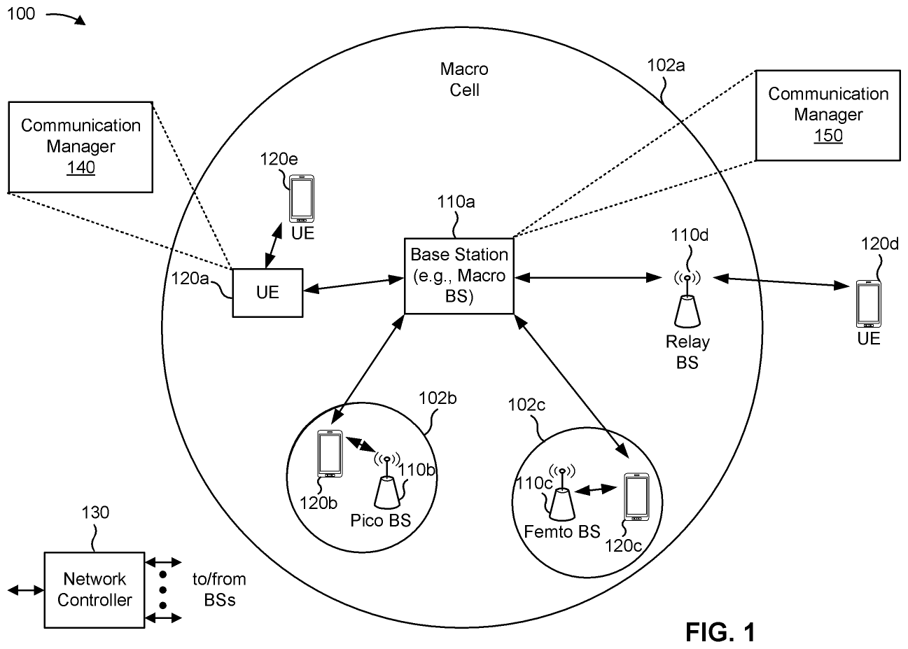

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a wireless device (e.g., an IoT device, a zero power device, a UE 120, an energy harvesting (EH) device) may include a communication manager 140. As described in more detail elsewhere herein, the communication manager 140 may receive a power up signal and transmit a backscattering signal that includes information bits, or receive commands or bits, at a power up time after starting reception of the power up signal, where the power up time is configured. Additionally, or alternatively, the communication manager 140 may perform one or more other operations described herein.

In some aspects, a wireless device (e.g., a UE 120, a charging device, base station 110, a network entity) may include a communication manager 140 or 150. As described in more detail elsewhere herein, the communication manager 140 or 150 may transmit a power up signal and receive a backscattering signal that includes information bits, or transmit commands or bits, at a power up time after starting transmission of the power up signal, where the power up time is configured or searched for. Additionally, or alternatively, the communication manager 140 or 150 may perform one or more other operations described herein.

As indicated above, FIG. 1 is provided as an example. Other examples may differ from what is described with regard to FIG. 1.

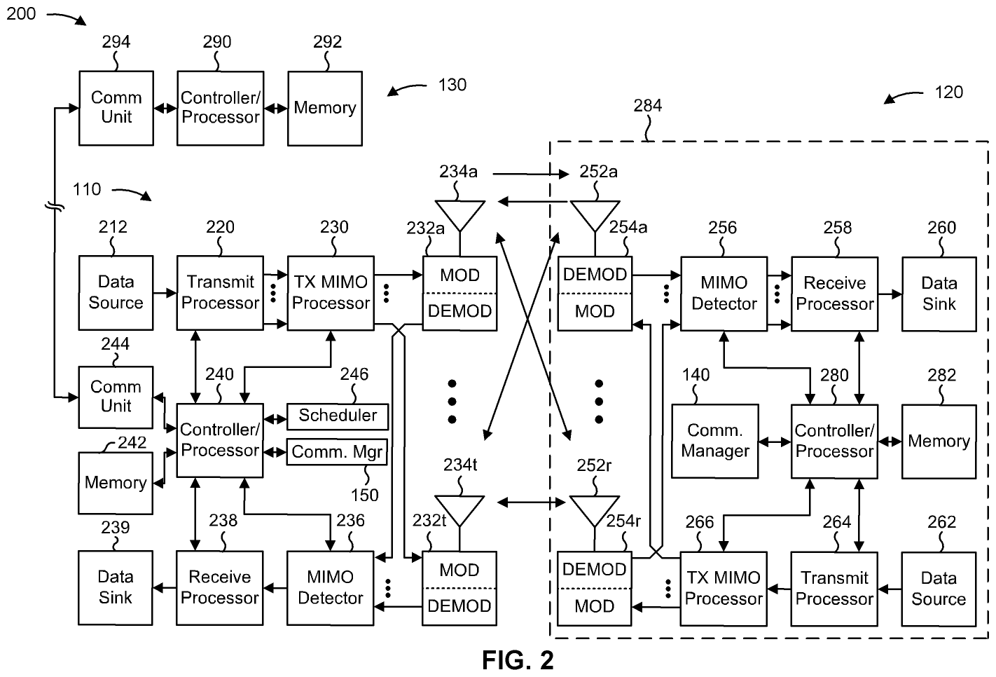

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

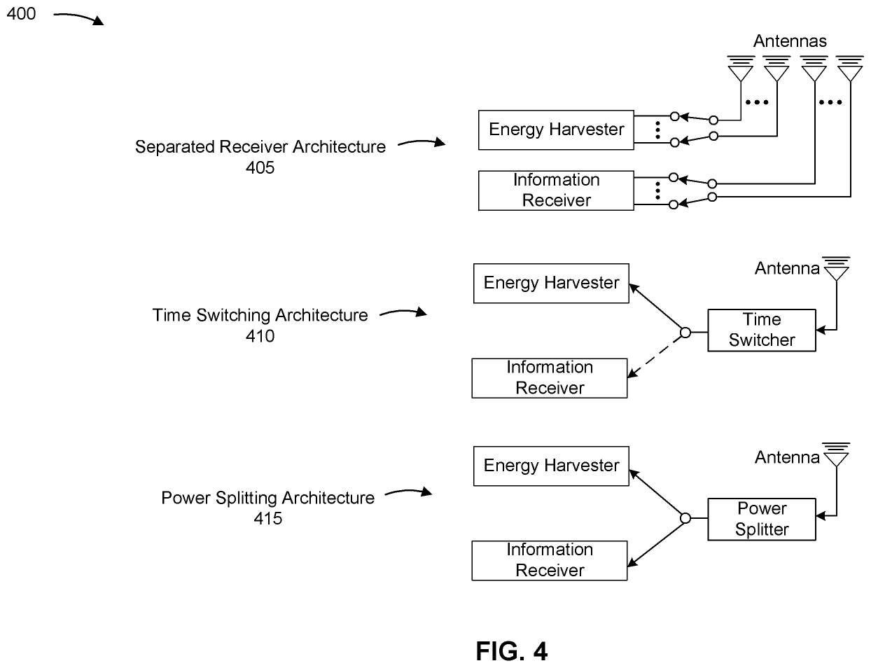

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

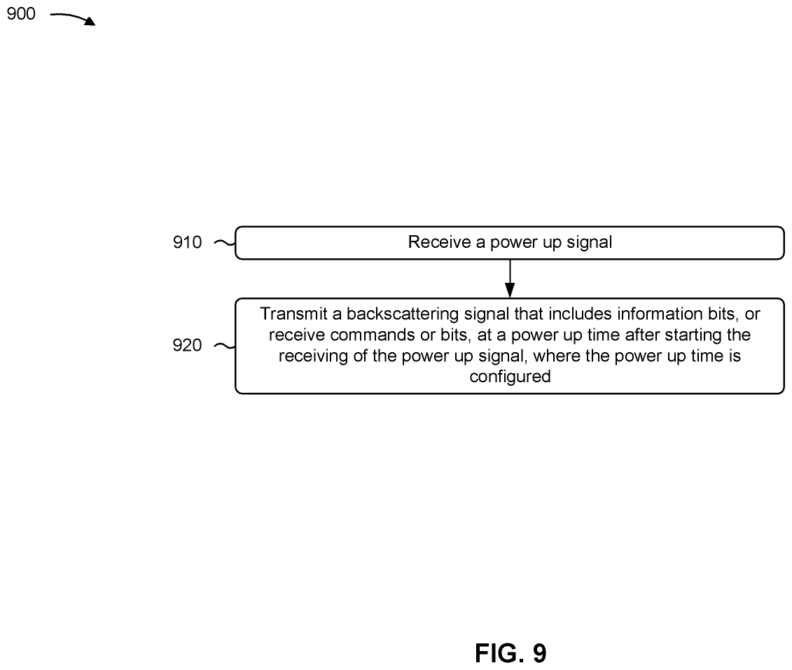

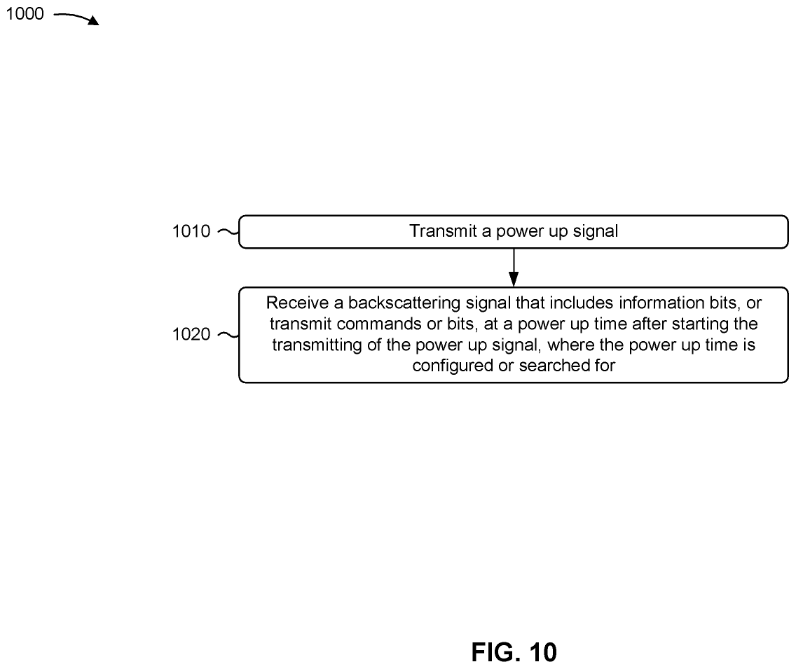

A controller/processor of a network entity, (e.g., the controller/processor 240 of the base station 110), the controller/processor 280 of the UE 120, and/or any other component(s) of FIG. 2 may perform one or more techniques associated with configuring a power up time for an EH device, as described in more detail elsewhere herein. In some aspects, the first device described herein is the UE 120, is included in the UE 120, or includes one or more components of the UE 120 shown in FIG. 2. In some aspects, the second device described herein is the UE 120 or the network entity, is included in the UE 120 or the network entity, or includes one or more components of the UE 120 or the base station 110 shown in FIG. 2. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a wireless device (e.g., an IoT device, a zero power device, a UE 120, an EH device) includes means for receiving a power up signal; and/or means for transmitting a backscattering signal that includes information bits, or receiving commands or bits, at a power up time after starting the receiving of the power up signal, where the power up time is configured. In some aspects, the means for the wireless device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a wireless device (e.g., a UE 120, a charging device, base station 110, a network entity) includes means for transmitting a power up signal; and/or means for receiving a backscattering signal that includes information bits, or transmitting commands or bits, at a power up time after starting the transmitting of the power up signal, where the power up time is configured or searched for. In some aspects, the means for the wireless device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the wireless device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

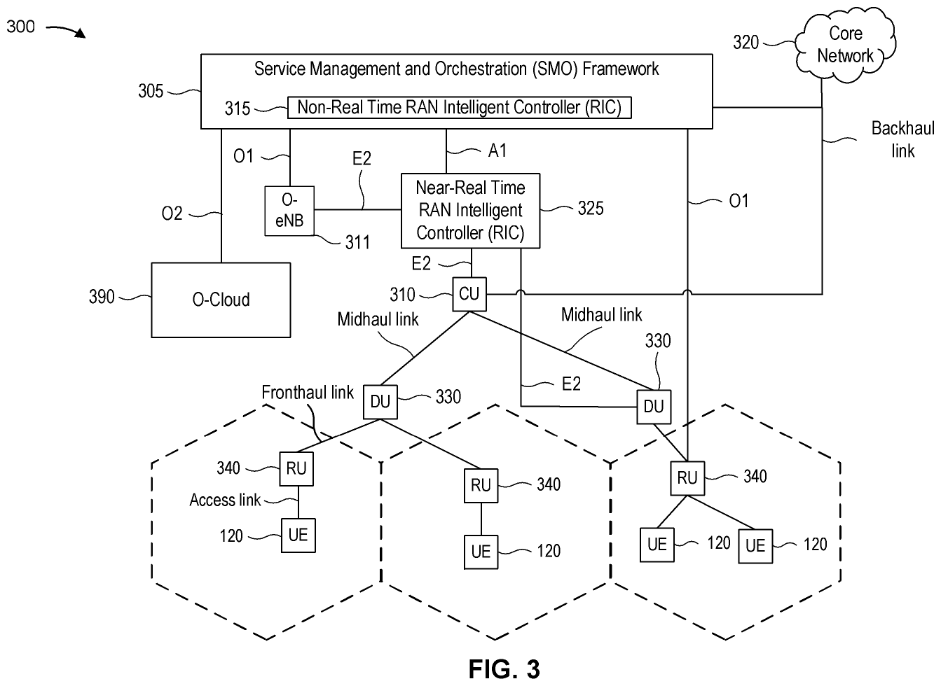

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RIC 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more radio frequency (RF) access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/MWL models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

FIG. 4 is a diagram illustrating an example 400 of energy harvesting, in accordance with the present disclosure.

Energy harvesting includes a device obtaining energy from a source other than an on-device battery. This may include obtaining energy from a source outside of the device. Devices that use energy harvesting may have a small energy storage device or battery (e.g., smart watch, RedCap devices, eRedCap devices) or no energy storage device or battery (e.g., zero-power devices, IoT devices, wearables, or financial devices). Energy harvesting may include converting RF energy transferred from another device. The harvesting of RF energy may not fully charge a battery but may be used for some tasks like data decoding, operating some filters, data reception, data encoding, data reception, and/or data transmission. The energy may be accumulated over time. Energy harvesting may also be a part of self-sustainable networks, where a node in the network can interact in the network through the energy harvested in the network through transmissions.

As shown in FIG. 4, an RF receiver (e.g., a UE 120) may receive signals (e.g., radio signals carried on radio waves) from an RF transmitter (e.g., a base station 110 or UE 120) and convert electromagnetic energy of the signals (e.g., using a rectenna comprising a dipole antenna with an RF diode) into direct current electricity for use by the RF receiver. The RF receiver may be a low-power device or a zero-power device. The RF transmitter may be referred to as a “charging device.”

As shown by reference number 405, in some aspects, the RF receiver may use a separated receiver architecture, where a first set of antennas is configured to harvest energy, and a second set of antennas is configured to receive data. In this scenario, each set of antennas may be separately configured to receive signals at certain times, frequencies, and/or via one or more particular beams, such that all signals received by the first set of antennas are harvested for energy, and all signals received by the second set of antennas are processed to receive information.

As shown by reference number 410, in some aspects, the RF receiver may use a time-switching architecture to harvest energy. The time switching architecture may use one or more antennas to receive signals, and whether the signals are harvested for energy or processed to receive information depends on the time at which the signals are received. For example, one or more first time slots may be time slots during which received signals are sent to one or more energy harvesting components to harvest energy, and one or more second time slots may be time slots during which received signals are processed and decoded to receive information. In some aspects, the time slots may be pre-configured (e.g., by the RF receiver, the RF transmitter, or another device).

As shown by reference number 415, in some aspects, the RF receiver may use a power splitting architecture to harvest energy. The power splitting architecture may use one or more antennas to receive signals, and the signals are handled by one or both of the energy harvesting and/or information receiving components according to an energy harvesting rate. For example, the RF receiver may be configured to use a first portion of received signals for energy harvesting and the remaining received signals for information receiving. The energy harvesting mode for a device may be semi-statistically configured by RRC messaging. In some aspects, the energy harvesting rate may be pre-configured (e.g., by the RF receiver, the RF transmitter, or another device). Communications with a network entity may be required, even in the energy harvesting mode, but with a reduced radio capability to reduce power consumption.

The RF receiver may receive signals for energy harvesting on certain resources (e.g., time, frequency, and/or spatial resources) and at a certain power level that results in a particular charging rate. Energy harvested by the RF receiver may be used and/or stored for later use. For example, in some aspects, the RF receiver may be powered directly by the harvested energy. In some aspects, the RF receiver may use an energy storage device, such as a battery, capacitor, and/or supercapacitor, to gather and store harvested energy for immediate and/or later use.

The energy harvesting device may have a low-power or wake-up radio that is configured to detect a low-power wake up signal (WUS) but not perform other communications. The energy harvesting device may have a main radio that is configured to perform communications and that consumes more power than the low-power radio or wake-up radio. The energy harvesting device may have limited RF capabilities (less than enhanced UE) or full RF capabilities (comparable to enhanced UE).

Energy harvesting devices, more generally, may rely equally or differently on different energy harvesting techniques such as solar power, vibration, thermal energy, or RF energy harvesting. Energy harvesting can be predictable or unpredictable due to the energy being intermittently available. Current communications use fixed activity cycles for transmission and reception, such as an on duration of an active DRX cycle. The active DRX cycle may include a part of the DRX cycle when a DRX on-duration timer (time UE is monitoring for physical downlink control channel (PDCCH) communications) or a DRX inactivity timer (time UE is active after successfully decoding a PDCCH communication) is running. A timer may run once it is started, until it is stopped or until it expires; otherwise it is not running. A timer may start if it is not running or restarted if it is running. A timer may be started or restarted from its initial value.

As indicated above, FIG. 4 is provided as an example. Other examples may differ from what is described with regard to FIG. 4.

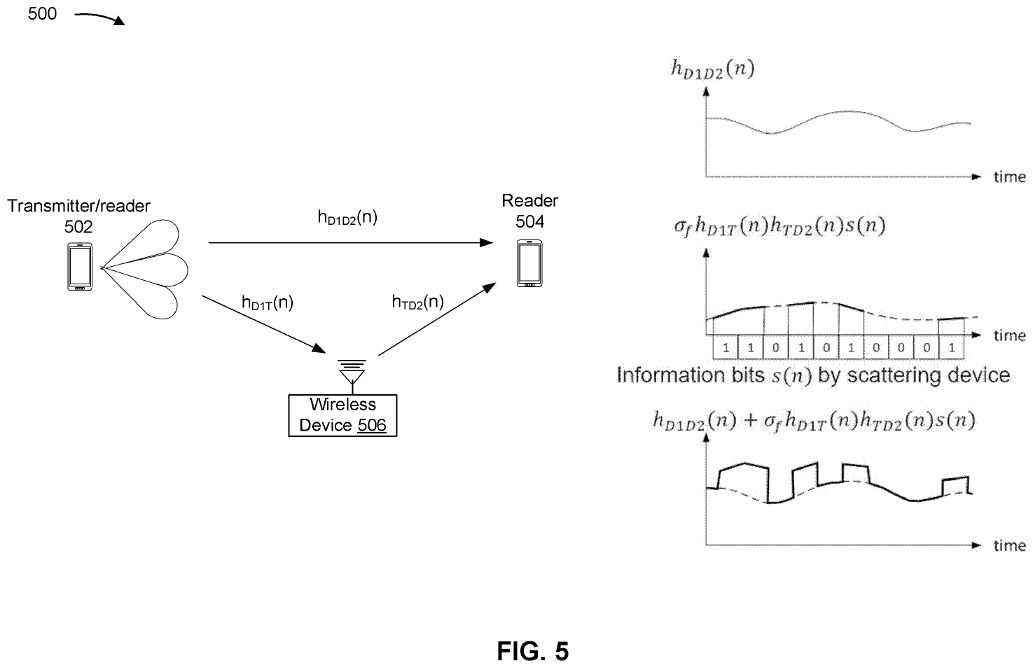

FIG. 5 is a diagram illustrating an example 500 of backscatter communication, in accordance with the present disclosure.

EH devices may include passive IoT devices (e.g., RFID tags) that rely on passive communication technologies, such as backscatter communication. Backscatter communication involves using an RF signal to write or transmit data without a battery or a power source. A transmitter/reader 502 may transmit a continuous wave (CW) signal (radio wave denoted as x(n)) that may be received by multiple devices, such as reader 504. A wireless device 506 (e.g., a passive IoT device, a UE 120 without energy source, a scattering device) may harvest energy (e.g., tens or hundreds of microwatts of electricity) from the signal. The wireless device 506 may use passive reflection and modulation of the signal to transmit a backscatter signal using the harvested energy. That is, the wireless device 506 may modulate the signal to encode data and then reflect a fraction of the wave to the reader 504 or to the transmitter/reader 502. The backscatter signal may be encoded with information bits (e.g., identifying information, sensor information) of the wireless device 506. The reader 504 may receive the backscatter signal and read the information bits. In some scenarios, the wireless device 506 may use information commands (e.g., write, transmit) or bits (e.g., data, configuration, indications) modulated in a received data or control signal to write commands or bits to the wireless device 506 itself.

One modulation method for backscattering includes amplitude shift keying (ASK), which switches on the reflection when transmitting information bit “1” and switches off the reflection when transmitting information bit “0”. If the information bits of backscatter device are s(n) ∈ {0,1}, the received signal at UE may be y(n)=(h_{D1D2}(n)+σ_{f}h_{D1T}(n)h_{TD2}(n)s(n))x(n)+noise. In example 500, D1 is transmitter/reader 502, D2 is reader 504, and T is the wireless device 506 for transmitted signal h. When s(n)=0, reflection is switched off at the wireless device 506 such that the reader 504 only receives a direct link signal (y(n)=h_{D1D2} (n)x(n)+nois). When s(n)=1, reflection is switched on at wireless device 506 such that the reader 504 receives the superposition of both the direct link signal and the backscatter, which is represented as y(n)=(h_{D1D2}(n)+σ_{f}h_{D1T}(n)h_{TD2}(n)s(n))x(n)+noise, where σ_{f} denotes the reflection coefficient.

To receive the transmitted information bits by the wireless device 506, the reader 504 may first decode x(n) based on the known h_{D1D2} (n), by treating the backscatter link signal as interference. The reader 504 may then detect the existence of the term σ_{f}h_{D1T}(n)h_{TD2}(n)s(n)x(n) by subtracting h_{D1D2}(n)x(n) from y(n).

Ultra-high frequency radio frequency identification (UHF RFID) systems may be based on backscatter communication. However, current UHF RFID systems are not compatible with NR systems. For example, RFID systems operate in an industrial, scientific, and medical (ISM) frequency band, while NR systems mainly operate in licensed bands. Furthermore, effective interference management between the systems has not been established.

As indicated above, FIG. 5 is provided as an example. Other examples may differ from what is described with regard to FIG. 5.

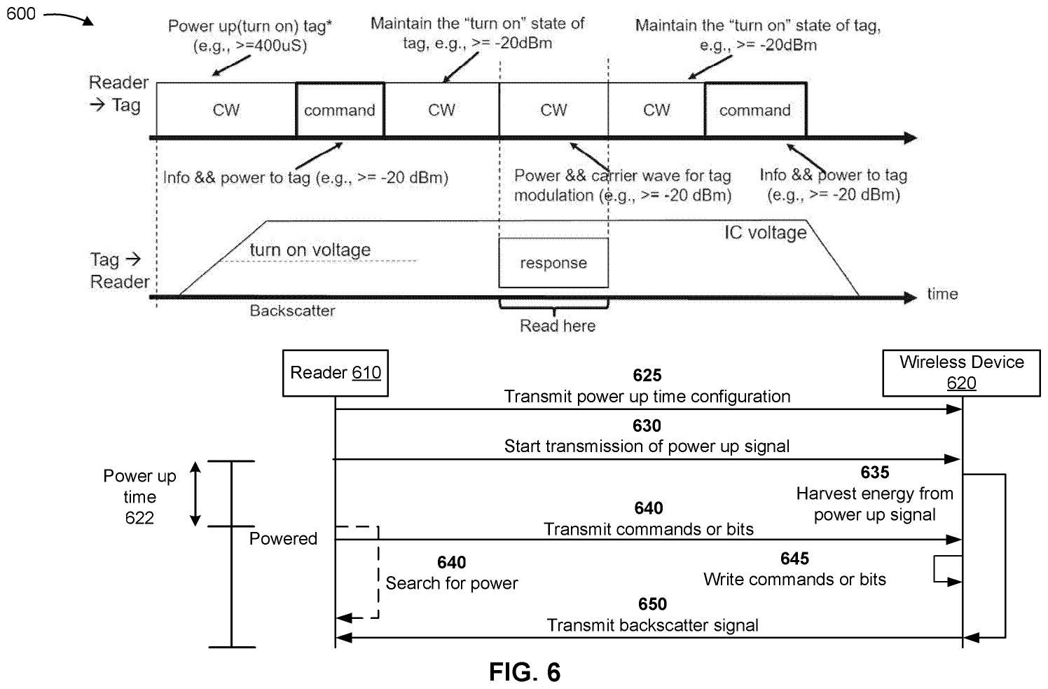

FIG. 6 is a diagram illustrating an example 600 associated with using a reserved EH duration to harvest energy, in accordance with the present disclosure. As shown in FIG. 6, a reader 610 (e.g., UE 120, a base station 110, a network entity) that may transmit RF energy to a wireless device 620 (e.g., RFID tag, an IoT device, EH device, a zero power device, a UE 120) for EH, for backscattering, or for writing commands or information bits to the wireless device 620. The wireless device 620 may not have its own power source and may require EH for operational power.

According to various aspects described herein, the wireless device 620 may be configured for operation in an NR network and may receive, from the reader 610, a power up signal to power up, or warm up, the wireless device 620. The power up signal may be a CW signal that starts before commands or bits are received in a data or control signal. Once the power for the wireless device reaches a turn on voltage, the wireless device 620 may be able to receive commands or bits that are modulated in the CW signal. The wireless device 620 may maintain the voltage and transmit a response (e.g., a backscattered signal with information bits). In some aspects, there may be a power up time 622 between when the CW signal starts and when the wireless device 620 is expected to have enough power for transmitting and writing. This power up time 622 may be a configured duration. For example, the power up time and initial (e.g., default) frequency is preconfigured, loaded to the wireless device 620, and determined by a power transmitter based at least in part on a device class or a device type of the wireless device 620. Reader 610 may transmit an indication of a preconfigured power up time 622 to the wireless device 620. In this way, both the reader 610 and the wireless device 620 may know when to expect powered operations by the wireless device 620.

As shown by reference number 625, the reader 610 may transmit a power up time configuration. This may be received at an earlier power up time 622 for the wireless device 620. As shown by reference number 630, the reader 610 may start transmission of a power up signal. As shown by reference number 635, the wireless device may harvest energy from the power up signal.

In some aspects, the EH circuits of the wireless device 620 are designed based at least in part on a set of frequencies to be used when the wireless device 620 is on. The wireless device 620 may indicate to the reader 610 which frequencies are best to use or for which frequencies the EH circuits are designed. The reader 610 may transmit the power up signal on those frequencies, frequency band, bandwidth part (BWP), or frequency range.

As shown by reference number 640, the reader may transmit the commands or bits in the data or control signal at or after an end of the power up time 622. The commands may be information commands that provide information or instructions to, for example, write, transmit, and/or change a power or communication configuration. The bits may be information bits, such as for data, a header, or other information. The power up time may be a specified quantity of slots or symbols before receiving the power up signal.

The wireless device 620 may autonomously start backscattering or writing whenever the wireless device 620 is ready. In this scenario, the reader 610 may have to search for when the wireless device 620 is powered up, as shown by reference number 640. Searching for when the wireless device 620 is powered up may be considered searching for the power up time used by the wireless device 620 or more specifically, searching for an end of the power up time. The reader 610 may search in configured time bins (time occasions). In other words, if the reader 610 has not configured the wireless device 620 with a power up time or is aware of a power up time used by the wireless device 620, the reader 610 may have to search for when the wireless device 620 is powered up to know the power up time used by the wireless device 620.

The reader 610 or a network entity (e.g., base station 110) may indicate a mode of operation to the wireless device 620 (and to reader 610), whether the mode is autonomous or relies on the power up time 622. The mode can be indicated via Layer 1 (L1), Layer 2 (L2), or Layer 3 (L3) signaling. If the source of the power up signal source is the reader 610, the mode may not need to be indicated. In some aspects, the reader 610 may indicate the mode to the wireless device 620. Alternatively, the wireless device 620 may start backscattering or writing at a specified point in time, such as the power up time 622 after the start of the power up signal.

As shown by reference number 640, the reader 610 may transmit the commands or bits in the data or control signal. This may be at a specified time based at least in part on the power up time 622 that is configured. The wireless device 620 should be sufficiently powered at this time and may write commands or bits that are received in the data or control signal, as shown by reference number 645. In some aspects, as shown by reference number 650, the wireless device 620 may transmit a backscatter signal that is modulated with information bits provided by the wireless device 620 and that is read by the reader 610. By using a configured power up time, the wireless device 620 and the reader 610 may better synchronize operations with when the wireless device 620 is sufficiently powered. As a result, the reader 610 does not waste power and signaling resources transmitting the commands or bits when the wireless device is not ready. The reader 610 and the wireless device 620 may also reduce latency.

In some aspects, the reader 610 may reduce latency by starting transmission of the power up signal in a previous time slot or symbols before an expected reading or writing operation. The power up signal may be started at the power up time 622 before the expected reading or writing operation. In some aspects, the reader 610 may configure the power up time 622, a starting time for the data or control signal, and/or a duration of the power up signal via a configured grant or dynamically via L1/L2/L3 signaling a specified amount of time (e.g., time, symbols, slots) before the expected reading or writing operation.

As indicated above, FIG. 6 is provided as an example. Other examples may differ from what is described with regard to FIG. 6.

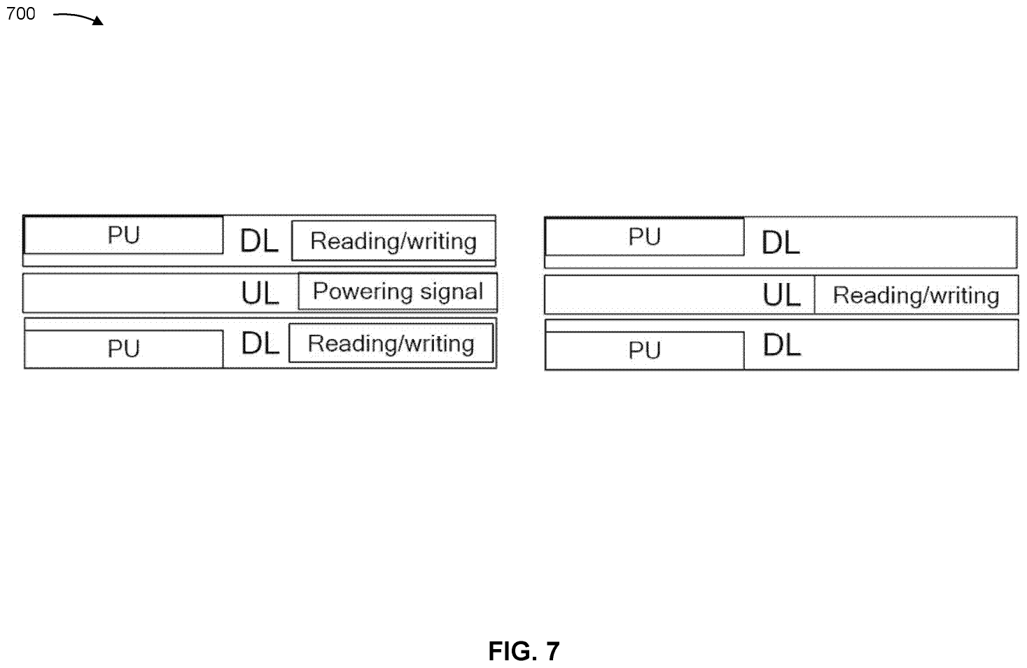

FIG. 7 is a diagram illustrating an example 700 of subbands for backscattering, in accordance with the present disclosure.

In some aspects, if the wireless device 620 is able to harvest energy on a frequency band that is different from the frequency band for the data or control signal or the backscattering signal and if the wireless device 620 is able to cease energy harvested (and cut) from the data or control signal, which may be the power up signal (which reduces the backscattered power if reading and the decoding power if writing), then the reader 610 or the network entity may indicate to the wireless device 620 to use a certain frequency band, BWP, frequency range, slot type (downlink or uplink), a subband full duplex (SBFD) slot, or a portion of an in-band FD (IBFD) slot to harvest energy and use the other portion for a reading or writing operation without a reduction of the data or control signal power. Example 700 shows the use of different subbands in frequency division multiplexing (FDM) for powering up the wireless device 620 and for reading or writing operations.

For reading, two or more RF sources can transmit the CW signal during the read time and thus power can be boosted even within the same band/time of data. However, for writing, unless the two RF sources have the same data to write to the wireless device 620, the network entity may assign a power signal in a different band (cannot be on the same band as the data to boost the power).

In some aspects, the wireless device 620 may transmit a message indicating a capability of the wireless device 620 to stop using a power up signal to harvest energy if necessary to maintain a transmit power for the backscattering signal. The message may indicate a class of the wireless device that is associated with capabilities for harvesting energy and transmitting backscattering signals or writing after the power up time 622.

In some aspects, the wireless device 620 may indicate a capability of using other signals (other than the signal used for data reading/writing) to harvest energy and/or a capability to stop using the data or control signal in harvesting whenever needed (to maintain the signal with high power). The wireless device 620 may not rely on the data or control signal to harvest energy. In other words, wireless device 630 may transmit a tag or other message that indicates a capability to use other signals to harvest energy besides the data or control signal used for data reading or writing and/or a capability to stop using the data or control signal in harvesting whenever needed (to maintain the signal with high power). The processor and/or integrated circuitry may not rely on the data or control signal for power. This will increase the range and assist in assigning a different frequency band for powering circuitry and for data transmission and reception.

As indicated above, FIG. 7 is provided as an example. Other examples may differ from what is described with regard to FIG. 7.

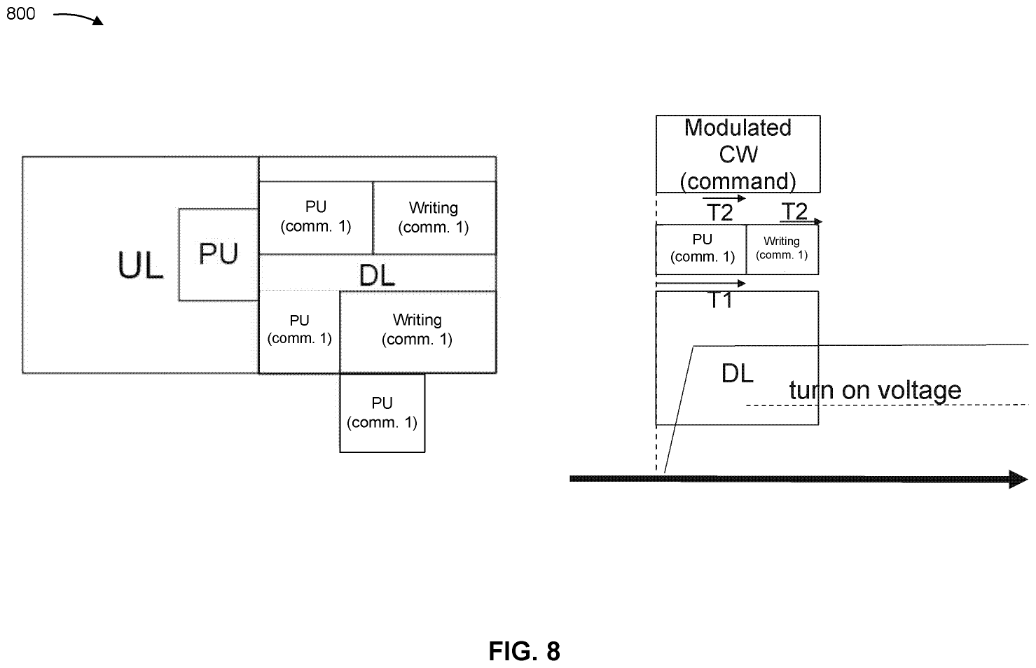

FIG. 8 is a diagram illustrating an example 800 of using repetitions, in accordance with the present disclosure.

Example 800 shows that a power up signal and a writing command may share a slot but operate to both power up the wireless device 620 and write a command to the wireless device 620. The duration of the power up signal may vary, along with the duration of the writing. If the power up signal has a long duration, the power up signal may include repeated information where there are specific times of when a repetition starts and is known to the wireless device 620. Once powered up, the wireless device 620 may use the remaining portion of the power up signal, which is a modulated CW (same as Command 1), to combine with the last part of the command (transmitted after T1). In some aspects, the power up signal includes at least a portion of data that starts at a specified time or bin of a slot and that is repeated in the data or control signal. This can improve the reliability for writing commands or information bits to the wireless device 620.

As indicated above, FIG. 8 is provided as an example. Other examples may differ from what is described with regard to FIG. 8.

FIG. 9 is a diagram illustrating an example process 900 performed, for example, by a wireless device, in accordance with the present disclosure. Example process 900 is an example where the wireless device (e.g., wireless device 620) performs operations associated with a configured power up time.

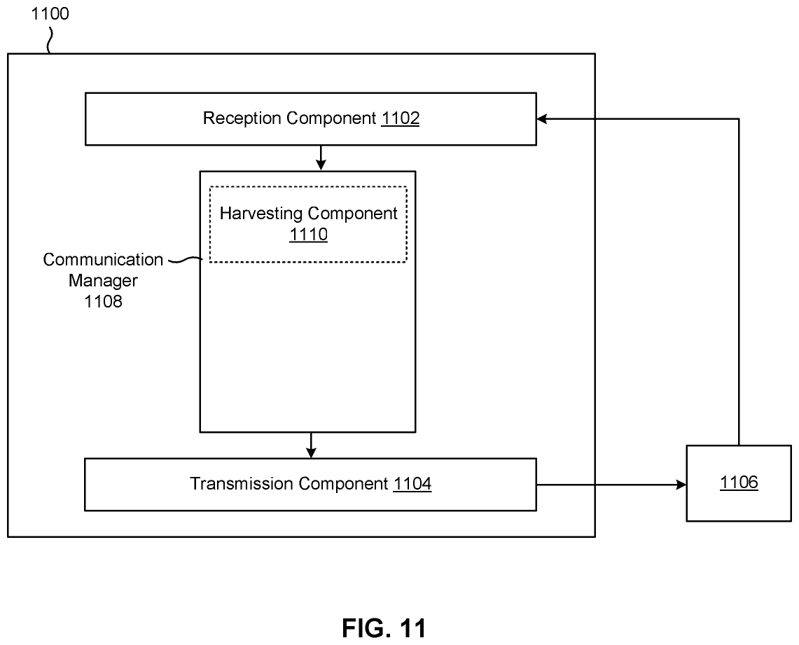

As shown in FIG. 9, in some aspects, process 900 may include receiving a power up signal (block 910). For example, the wireless device (e.g., using communication manager 1108 and/or reception component 1102 depicted in FIG. 11) may receive a power up signal, as described above.

As further shown in FIG. 9, in some aspects, process 900 may include transmitting a backscattering signal that includes information bits, or receiving commands or bits, at a power up time after starting the receiving of the power up signal, where the power up time is configured (block 920). For example, the wireless device (e.g., using communication manager 1108 and/or transmission component 1104 depicted in FIG. 11) may transmit a backscattering signal that includes information bits, or receive commands or bits, at a power up time after starting reception of the power up signal, where the power up time is configured, as described above.

Process 900 may include additional aspects, such as any single aspect or any combination of aspects described below and/or in connection with one or more other processes described elsewhere herein.

In a first aspect, the power up signal is a wake up signal.

In a second aspect, alone or in combination with the first aspect, the power up time is preconfigured.

In a third aspect, alone or in combination with one or more of the first and second aspects, the power up time and initial (e.g., default) frequency is preconfigured, loaded to the wireless device, and determined by a power transmitter based at least in part on a device class or a device type of the wireless device.

In a fourth aspect, alone or in combination with one or more of the first through third aspects, process 900 includes receiving an indication of one or more of frequency resources or time resources to use for energy harvesting, and harvesting energy using the one or more of frequency resources or time resources.

In a fifth aspect, alone or in combination with one or more of the first through fourth aspects, harvesting energy includes harvesting energy concurrently with the transmitting the backscattering signal or the receiving the commands or bits.

In a sixth aspect, alone or in combination with one or more of the first through fifth aspects, the transmitting the backscattering signal or the receiving the commands or bits, and the harvesting energy, occur in a same frequency band.

In a seventh aspect, alone or in combination with one or more of the first through sixth aspects, the transmitting the backscattering signal or the receiving the commands or bits, and the harvesting energy, occur in different frequency bands.

In an eighth aspect, alone or in combination with one or more of the first through seventh aspects, process 900 includes transmitting a message indicating a capability of the wireless device to concurrently harvest energy and transmit the backscattering signal or receive and/or receive the commands or bits.

In a ninth aspect, alone or in combination with one or more of the first through eighth aspects, process 900 includes transmitting transmit a message indicating a capability of the wireless device to stop using a signal that will be backscattered or a modulated signal carrying data that is partially used to power the wireless device, and to rely on other bands or signals for power.

In a tenth aspect, alone or in combination with one or more of the first through ninth aspects, process 900 includes transmitting a message indicating a class of the wireless device that is associated with capabilities for harvesting energy and transmitting backscattering signals or writing after the power up time.

In an eleventh aspect, alone or in combination with one or more of the first through tenth aspects, the power up signal includes at least a portion of data that starts at a specified time or bin of a slot and that is repeated in the commands orbits.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a wireless device, in accordance with the present disclosure. Example process 1000 is an example where the wireless device (e.g., a UE 120, reader 610, a network entity) performs operations associated with using a configured power up time.

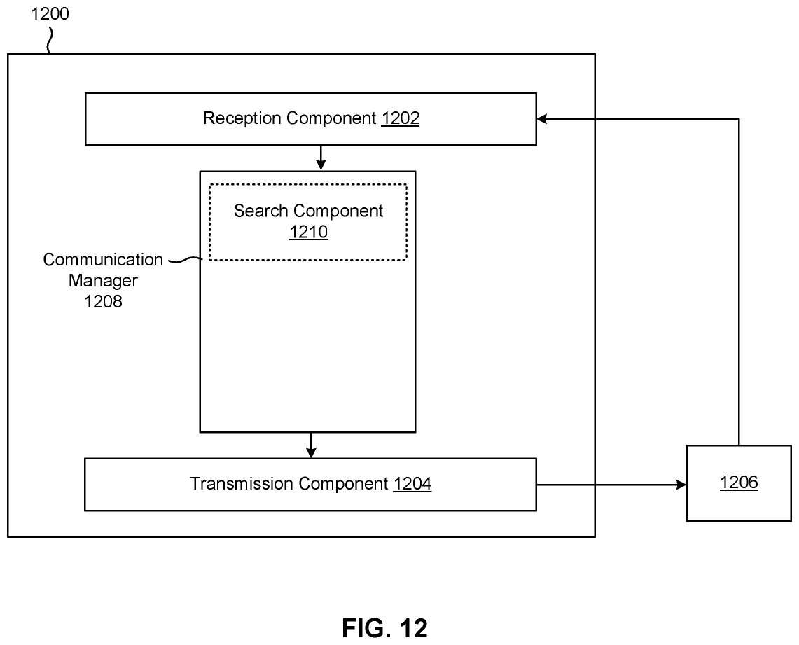

As shown in FIG. 10, in some aspects, process 1000 may include transmitting a power up signal (block 1010). For example, the wireless device (e.g., using communication manager 1208 and/or transmission component 1204 depicted in FIG. 12) may transmit a power up signal, as described above.

As further shown in FIG. 10, in some aspects, process 1000 may include receiving a backscattering signal that includes information bits, or transmitting commands or bits, at a power up time after starting the transmitting the power up signal, where the power up time is configured or searched for (block 1020). For example, the wireless device (e.g., using communication manager 1208 and/or reception component 1202 depicted in FIG. 12) may receive a backscattering signal that includes information bits, or transmit commands or bits, at a power up time after starting transmission of the power up signal, where the power up time is configured or searched for, as described above.

Process 1000 may include additional aspects, such as any single aspect or any combination of aspects described below and/or in connection with one or more other processes described elsewhere herein.

In a first aspect, the power up signal is a wake up signal.

In a second aspect, alone or in combination with the first aspect, the power up time is preconfigured.

In a third aspect, alone or in combination with one or more of the first and second aspects, process 1000 includes searching for a start of the backscattering signal.

In a fourth aspect, alone or in combination with one or more of the first through third aspects, transmitting the power up signal includes starting the transmitting of the power up signal in a slot before a slot of the receiving the backscattering signal or the transmitting the data or control signal.

In a fifth aspect, alone or in combination with one or more of the first through fourth aspects, process 1000 includes transmitting an indication of the power up time a specified quantity of slots or symbols before receiving the power up signal.

In a sixth aspect, alone or in combination with one or more of the first through fifth aspects, process 1000 includes transmitting an indication of one or more of frequency resources or time resources to use for energy harvesting, and transmitting the power up signal using the one or more of frequency resources or time resources.

In a seventh aspect, alone or in combination with one or more of the first through sixth aspects, transmitting the power up signal includes transmitting the power up signal concurrently with receiving the backscattering signal or transmitting the commands or bits.

In an eighth aspect, alone or in combination with one or more of the first through seventh aspects, the receiving the backscattering signal or the transmitting the commands or bits, and the transmitting the power up signal, occur in a same frequency band.

In a ninth aspect, alone or in combination with one or more of the first through eighth aspects, the receiving the backscattering signal or the transmitting the commands or bits, and the transmitting the power up signal, occur in different frequency bands.

In a tenth aspect, alone or in combination with one or more of the first through ninth aspects, process 1000 includes receiving a message indicating a capability of the wireless device to concurrently harvest energy and transmit the backscattering signal or receive commands or bits, and transmitting the commands or bits includes transmitting the commands or bits based at least in part on the capability.

In an eleventh aspect, alone or in combination with one or more of the first through tenth aspects, process 1000 includes receiving a message indicating a capability of the wireless device to stop using a signal that will be backscattered or a modulated signal carrying data that is partially used to power the wireless device and to rely on other bands or signals for power, and transmitting the power up signal includes transmitting the power up signal based at least in part on the capability.

In a twelfth aspect, alone or in combination with one or more of the first through eleventh aspects, process 1000 includes receiving a message indicating a class of the wireless device that is associated with a capability for harvesting energy and transmitting backscattering signals or receiving commands or bits after the power up time, and transmitting the commands or bits includes transmitting the commands or bits based at least in part on the capability.

In a thirteenth aspect, alone or in combination with one or more of the first through twelfth aspects, the power up signal includes at least a portion of data that starts at a specified time or bin of a slot and that is repeated in the commands or bits.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a wireless device (e.g., a UE 120, wireless device 506, wireless device 620), or a wireless device may include the apparatus 1100.

In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 1108. The communication manager 1108 may control and/or otherwise manage one or more operations of the reception component 1102 and/or the transmission component 1104. In some aspects, the communication manager 1108 may include one or more antennas, a modem, a controller/processor, a memory, or a combination thereof, of the UE described in connection with FIG. 2. The communication manager 1108 may be, or be similar to, the communication manager 140 depicted in FIGS. 1 and 2. For example, in some aspects, the communication manager 1108 may be configured to perform one or more of the functions described as being performed by the communication manager 140. In some aspects, the communication manager 1108 may include the reception component 1102 and/or the transmission component 1104. The communication manager 1108 may include a harvesting component 1110, among other examples.

In some aspects, the apparatus 1100 may be configured to perform one or more operations described herein in connection with FIGS. 1-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the wireless device described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the wireless device described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the wireless device described in connection with FIG. 2. In some aspects, the transmission component 1104 may be co-located with the reception component 1102 in a transceiver.

The reception component 1102 may receive a power up signal. The transmission component 1104 may transmit a backscattering signal that includes information bits, or receive commands or bits, at a power up time after starting the receiving of the power up signal, where the power up time is configured.

The reception component 1102 may receive an indication of the power up time a specified quantity of slots or symbols before receiving the power up signal. The reception component 1102 may receive an indication of one or more of frequency resources or time resources to use for energy harvesting. The harvesting component 1110 may harvest energy using the one or more of frequency resources or time resources.

The transmission component 1104 may transmit a message indicating a capability of the wireless device to concurrently harvest energy and transmit the backscattering signal or receive commands or bits. The transmission component 1104 may transmit a message indicating a capability of the wireless device to stop using a power up signal to harvest energy if necessary to maintain a transmit power for the backscattering signal. The transmission component 1104 may transmit a message indicating a class of the wireless device that is associated with capabilities for harvesting energy and transmitting backscattering signals or writing after the power up time.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a wireless device (e.g., reader 610, network entity), or a wireless device may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208. The communication manager 1208 may control and/or otherwise manage one or more operations of the reception component 1202 and/or the transmission component 1204. In some aspects, the communication manager 1208 may include one or more antennas, a modem, a controller/processor, a memory, or a combination thereof, of the UE or the base station described in connection with FIG. 2. The communication manager 1208 may be, or be similar to, the communication manager 150 depicted in FIGS. 1 and 2. For example, in some aspects, the communication manager 1208 may be configured to perform one or more of the functions described as being performed by the communication manager 150. In some aspects, the communication manager 1208 may include the reception component 1202 and/or the transmission component 1204. The communication manager 1208 may include a search component 1210, among other examples.

In some aspects, the apparatus 1200 may be configured to perform one or more operations described herein in connection with FIGS. 1-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the wireless device described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the wireless device described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the wireless device described in connection with FIG. 2. In some aspects, the transmission component 1204 may be co-located with the reception component 1202 in a transceiver.

The transmission component 1204 may transmit a power up signal. The reception component 1202 may receive a backscattering signal that includes information bits, or transmit commands or bits, at a power up time after starting the transmitting the power up signal, where the power up time is configured or searched for. The search component 1210 may search for a start of the backscattering signal.

The transmission component 1204 may transmit an indication of the power up time a specified quantity of slots or symbols before receiving the power up signal. The transmission component 1204 may transmit an indication of one or more of frequency resources or time resources to use for energy harvesting. The transmission component 1204 may transmit the power up signal using the one or more of frequency resources or time resources.

The reception component 1202 may receive a message indicating a capability of the wireless device to concurrently harvest energy and transmit the backscattering signal or receive commands or bits, and transmit the commands or bits based at least in part on the capability. The reception component 1202 may receive a message indicating a capability of the wireless device to stop using a power up signal to harvest energy if necessary to maintain a transmit power for the backscattering signal, and transmit the power up signal based at least in part on the capability. The reception component 1202 may receive a message indicating a class of the wireless device that is associated with a capability for harvesting energy and transmitting backscattering signals or receiving commands or bits after the power up time, and transmit the data or control signal based at least in part on the capability.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a wireless device, comprising: receiving a power up signal; and transmitting a backscattering signal that includes information bits, or receive commands or bits, at a power up time after starting reception of the power up signal, wherein the power up time is configured.

Aspect 2: The method of Aspect 1, wherein the power up signal is awake up signal.

Aspect 3: The method of Aspect 1 or 2, wherein the power up time and initial frequency is preconfigured, loaded to the wireless device, and determined by a power transmitter based at least in part on a device class or a device type of the wireless device.

Aspect 4: The method of any of Aspects 1-3, further comprising receiving an indication of the power up time a specified quantity of slots or symbols before receiving the power up signal.

Aspect 5: The method of any of Aspects 1-4, further comprising: receiving an indication of one or more of frequency resources or time resources to use for energy harvesting; and harvesting energy using the one or more of frequency resources or time resources.

Aspect 6: The method of Aspect 5, wherein harvesting energy includes harvesting energy concurrently with the transmitting the backscattering signal or the receiving the commands or bits.

Aspect 7: The method of Aspect 6, wherein the transmitting the backscattering signal or the receiving the commands or bits, and the harvesting energy, occur in a same frequency band.

Aspect 8: The method of Aspect 6, wherein the transmitting the backscattering signal or the receiving the commands or bits, and the harvesting energy, occur in different frequency bands.

Aspect 9: The method of any of Aspects 1-8, further comprising transmitting a message indicating a capability of the wireless device to concurrently harvest energy and transmit the backscattering signal or receive commands or bits.

Aspect 10: The method of any of Aspects 1-9, further comprising transmitting a message indicating a capability of the wireless device to stop using a signal that will be backscattered or a modulated signal carrying data that is partially used to power the wireless device, and to rely on other bands or signals for power.

Aspect 11: The method of any of Aspects 1-10, further comprising transmitting a message indicating a class of the wireless device that is associated with capabilities for harvesting energy and transmitting backscattering signals or writing after the power up time.

Aspect 12: The method of any of Aspects 1-11, wherein the power up signal includes at least a portion of data that starts at a specified time or bin of a slot and that is repeated in the commands or bits.

Aspect 13: A method of wireless communication performed by a wireless device, comprising: transmitting a power up signal; and receiving a backscattering signal that includes information bits, or transmit commands or bits, at a power up time after starting transmission of the power up signal, wherein the power up time is configured or searched for.

Aspect 14: The method of Aspect 13, wherein the power up signal is a wake up signal.

Aspect 15: The method of Aspect 13 or 14, wherein the power up time is preconfigured.

Aspect 16: The method of any of Aspects 13-15, further comprising searching for a start of the backscattering signal.

Aspect 17: The method of any of Aspects 13-16, wherein transmitting the power up signal includes starting the transmitting of the power up signal in a slot before a slot of the receiving the backscattering signal or the transmitting the commands or bits.

Aspect 18: The method of any of Aspects 13-17, further comprising transmitting an indication of the power up time a specified quantity of slots or symbols before receiving the power up signal.

Aspect 19: The method of any of Aspects 13-18, further comprising: transmitting an indication of one or more of frequency resources or time resources to use for energy harvesting; and transmitting the power up signal using the one or more of frequency resources or time resources.

Aspect 20: The method of any of Aspects 13-19, wherein transmitting the power up signal includes transmitting the power up signal concurrently with receiving the backscattering signal or transmitting the commands or bits.

Aspect 21: The method of Aspect 20, wherein the receiving the backscattering signal or the transmitting the data or control signal, and the transmitting the power up signal, occur in a same frequency band.

Aspect 22: The method of Aspect 20, wherein the receiving the backscattering signal or the transmitting the commands or bits, and the transmitting the power up signal, in different frequency bands.

Aspect 23: The method of any of Aspects 13-22, further comprising receiving a message indicating a capability of the wireless device to concurrently harvest energy and transmit the backscattering signal or receive commands or bits, and wherein transmitting the commands or bits includes transmitting the commands or bits based at least in part on the capability.

Aspect 24: The method of any of Aspects 13-23, further comprising receiving a message indicating a capability of the wireless device to stop using a signal that will be backscattered or a modulated signal carrying data that is partially used to power the wireless device and to rely on other bands or signals for power, and wherein transmitting the commands or bits includes transmitting the commands or bits based at least in part on the capability.

Aspect 25: The method of any of Aspects 13-24, further comprising receiving a message indicating a class of the wireless device that is associated with a capability for harvesting energy and transmitting backscattering signals or receiving commands or bits after the power up time, and wherein transmitting the commands or bits includes transmitting the commands or bits based at least in part on the capability.

Aspect 26: The method of any of Aspects 13-25, wherein the power up signal includes at least a portion of data that starts at a specified time or bin of a slot and that is repeated in the commands or bits.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A wireless device for wireless communication, comprising:
a memory; and
one or more processors, coupled to the memory, configured to:
receive a power up signal; and
transmit a backscattering signal that includes information bits, or receive commands or bits, at a power up time after starting reception of the power up signal, wherein the power up time is configured.

2. The wireless device of claim 1, wherein the power up signal is a wake up signal.

3. The wireless device of claim 1, wherein the power up time and initial frequency is preconfigured, loaded to the wireless device, and determined by a power transmitter based at least in part on a device class or a device type of the wireless device.

4. The wireless device of claim 1, wherein the one or more processors are configured to receive an indication of the power up time a specified quantity of slots or symbols before receiving the power up signal.

5. The wireless device of claim 1, wherein the one or more processors are configured to:
receive an indication of one or more of frequency resources or time resources to use for energy harvesting; and
harvest energy using the one or more of frequency resources or time resources.

6. The wireless device of claim 5, wherein the one or more processors, to harvest energy, are configured to harvest energy concurrently with transmission of the backscattering signal or reception of the commands or bits.

7. The wireless device of claim 6, wherein the transmission of the backscattering signal or the reception of the commands or bits, and the harvest of energy, occur in a same frequency band.

8. The wireless device of claim 6, wherein the transmission of the backscattering signal or the reception of the commands or bits, and the harvest of energy, occur in different frequency bands.

9. The wireless device of claim 1, wherein the one or more processors are configured to transmit a message indicating a capability of the wireless device to concurrently harvest energy and transmit the backscattering signal or receive commands or bits.

10. The wireless device of claim 1, wherein the one or more processors are configured to transmit a message indicating a capability of the wireless device to stop using a signal that will be backscattered or a modulated signal carrying data that is partially used to power the wireless device, and to rely on other bands or signals for power.

11. The wireless device of claim 1, wherein the one or more processors are configured to transmit a message indicating a class of the wireless device that is associated with capabilities for harvesting energy and transmitting backscattering signals or writing after the power up time.

12. The wireless device of claim 1, wherein the power up signal includes at least a portion of data that starts at a specified time or bin of a slot and that is repeated in the commands or bits.

13. A wireless device for wireless communication, comprising:
a memory; and
one or more processors, coupled to the memory, configured to:
transmit a power up signal; and
receive a backscattering signal that includes information bits, or transmit commands or bits, at a power up time after starting transmission of the power up signal, wherein the power up time is configured or searched for.

14. The wireless device of claim 13, wherein the power up signal is a wake up signal.

15. The wireless device of claim 13, wherein the power up time is preconfigured.

16. The wireless device of claim 13, wherein the one or more processors are configured to search for a start of the backscattering signal.

17. The wireless device of claim 13, wherein the one or more processors, to transmit the power up signal, are configured to start transmission of the power up signal in a slot before a slot of reception of the backscattering signal or transmission of the commands or bits.

18. The wireless device of claim 13, wherein the one or more processors are configured to transmit an indication of the power up time a specified quantity of slots or symbols before receiving the power up signal.

19. The wireless device of claim 13, wherein the one or more processors are configured to:
transmit an indication of one or more of frequency resources or time resources to use for energy harvesting; and
transmit the power up signal using the one or more of frequency resources or time resources.

20. The wireless device of claim 13, wherein the one or more processors, to transmit the power up signal, are configured to transmit the power up signal concurrently with reception of the backscattering signal or transmission of the commands or bits.

21. The wireless device of claim 20, wherein the reception of the backscattering signal or the transmission of the commands or bits, and the transmission of the power up signal, occur in a same frequency band.

22. The wireless device of claim 20, wherein the reception of the backscattering signal or the transmission of the commands or bits, and the transmission of the power up signal, occur in different frequency bands.

23. The wireless device of claim 13, wherein the one or more processors are configured to receive a message indicating a capability of the wireless device to concurrently harvest energy and transmit the backscattering signal or receive commands or bits, and wherein the one or more processors, to transmit the commands or bits, are configured to transmit the commands or bits based at least in part on the capability.

24. The wireless device of claim 13, wherein the one or more processors are configured to receive a message indicating a capability of the wireless device to stop using a signal that will be backscattered or a modulated signal carrying data that is partially used to power the wireless device and to rely on other bands or signals for power, and wherein the one or more processors, to transmit the commands or bits, are configured to transmit the power up signal based at least in part on the capability.

25. The wireless device of claim 13, wherein the one or more processors are configured to receive a message indicating a class of the wireless device that is associated with a capability for harvesting energy and transmitting backscattering signals or receiving commands or bits after the power up time, and wherein the one or more processors, to transmit the commands or bits, are configured to transmit the commands or bits based at least in part on the capability.

26. The wireless device of claim 13, wherein the power up signal includes at least a portion of data that starts at a specified time or bin of a slot and that is repeated in the commands or bits.

27. A method of wireless communication performed by a wireless device, comprising:
receiving a power up signal; and
transmitting a backscattering signal that includes information bits, or receiving commands or bits, at a power up time after starting the receiving of the power up signal, wherein the power up time is configured.

28. The method of claim 27, further comprising receiving an indication of the power up time a specified quantity of slots or symbols before receiving the power up signal.

29. A method of wireless communication performed by a wireless device, comprising:
transmitting a power up signal; and
receiving a backscattering signal that includes information bits, or transmitting commands or bits, at a power up time after starting the transmitting of the power up signal, wherein the power up time is configured or searched for.

30. The method of claim 29, further comprising searching for a start of the backscattering signal.
